(19) United States
(12) Patent Application Publication
(10) Pub. No.: US 2025/0070498 A1
(43) Pub. Date: Feb. 27, 2025

(54) RELIABLE RECEPTACLE CONNECTOR

(71) Applicant: Amphenol East Asia Electronic Technology (Shenzhen) Co., Ltd., Shenzhen (CN)

(72) Inventors: Kangqin Li, Shenzhen (CN); Zhimin Qin, Shenzhen (CN)

(73) Assignee: Amphenol East Asia Electronic Technology (Shenzhen) Co., Ltd., Shenzhen (CN)

(21) Appl. No.: 18/809,576

(22) Filed: Aug. 20, 2024

(30) Foreign Application Priority Data
Aug. 22, 2023 (CN) 202322262902.X

(51) Int. Cl. H01R 13/502; H01R 13/52; H01R 13/627; H01R 13/6581; H01R 24/60; H01R 43/24

(52) U.S. Cl. CPC H01R 13/502; H01R 13/5202; H01R 13/6271; H01R 13/6581; H01R 24/60; H01R 43/24

(57) ABSTRACT

A reliable receptacle connector and method of manufacturing thereof. The connector includes a terminal assembly having conductive elements held by a housing. Each conductive element has a mating end held by a housing tongue, a tail end extending outside the housing, and an intermediate portion partially held by portions of the housing that have different contours. The terminal assembly can be formed by assembling terminal subassemblies on opposite sides of a shield and molding over the assembly to form the housing. An inner shell is sleeved on the housing and engages with both portions of the housing that have different contours. A main shell is sleeved on the inner shell. An outer shell is sleeved on the main shell and shaped such that a seal can be formed between the shells. Such a configuration enables distributing forces to mate/unmate the connector from the shells to the housing and therefore reduces relevant movements between the components of the connector.

### CROSS-REFERENCE TO RELATED APPLICATIONS

This application claims priority to and the benefit of Chinese Patent Application Serial No. 202322262902.X, filed on Aug. 22, 2023, the contents of which are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

Some USB connectors are water resistant. These connectors may include seals that block water from outside the computer enclosure from entering the computer enclosure through the opening left for the connector.

### BRIEF SUMMARY

Aspects of the present application relate to reliable receptable connectors.

Some embodiments relate to a receptacle connector. The receptacle connector may comprise a housing comprising a first portion having a first contour, a second portion extending from the first portion and having a second contour smaller than the first contour of the first portion, and a tongue extending from the second portion; a plurality of conductive elements, each of the plurality of conductive elements comprising a mating end held by the tongue portion of the housing, a tail end extending out of the housing, and an intermediate portion between the mating end and the tail end and at least partially held by the first and second portions of the housing; and an inner shell comprising a first portion engaging the first portion of the housing, and a second portion engaging the second portion of the housing.

Optionally, the first portion of the housing comprises a recess; and the first portion of the inner shell comprises a latch disposed in the recess of the first portion of the housing.

Optionally, the inner shell comprises an opening; and the housing comprises a protrusion disposed in the opening of the inner shell.

Optionally, the protrusion of the housing extends from the first portion of the housing to the second portion of the housing.

Optionally, a cross-section of the protrusion of the housing is L-shaped.

Optionally, the inner shell comprises a flange joining the first portion of the inner shell and the second portion of the inner shell; and the opening of the inner shell extends from the flange to the second portion of the inner shell.

Optionally, the housing comprises a third portion having a third contour larger than the first contour; and the first portion of the housing is disposed between the third portion of the housing and the second portion of the housing.

Optionally, the receptacle connector comprises a main shell disposed outside the inner shell and comprising a rear end abutting a front face of the third portion of the housing and a mating end extending beyond the tongue of the housing.

Optionally, the receptacle connector comprises an outer shell disposed outside the main shell, the outer shell comprising a mating end having a flange and a rear end having a plurality of mounting legs; and a seal disposed between the flange of the outer shell and the mating end of the main shell.

Optionally, the mating end of the main shell has a surface roughness higher than other portions of the main shell; and the seal comprises cured adhesive.

Some embodiments relate to a receptacle connector. The receptacle connector may comprise a shielding member comprising a plurality of holes; a plurality of conductive elements each comprising a mating end, a tail end, and an intermediate portion between the mating end and the tail end, the plurality of conductive elements comprising a first plurality disposed on a first side of the shielding member and a second plurality disposed on a second side of the shielding member opposite the first side; and a housing comprising a plurality of protrusions disposed in respective holes of the plurality of holes of the shielding member, each of the plurality of protrusions comprising a body and a plurality of projections extending radially from the body to engage edges of the respective holes.

Optionally, the housing comprises a first portion and a second portion extending from the first portion; and the receptacle connector comprises an inner shell comprising a first portion disposed on the first portion of the housing, a flange extending from the first portion, and a second portion extending from the flange and disposed on the second portion of the housing.

Optionally, the second portion of the housing comprises the plurality of protrusions disposed in the respective holes of the plurality of holes of the shielding member.

Optionally, the housing comprises a third portion disposed on a different side of the first portion of the housing from the second portion of the housing and spaced from the first portion of the housing; and the receptacle connector comprises a main shell having a rear end abutting a front face of the third portion of the housing.

Optionally, the receptacle connector comprises an outer shell disposed outside the main shell and having a rear end abutting the front face of the third portion of the housing, wherein the rear end of the outer shell comprises a plurality of mounting legs extending beyond the third portion of the housing.

Optionally, the main shell comprises a mating end having a surface roughness higher than other portions of the main shell; the receptacle connector comprises a seal disposed on the mating end of the main shell; and the seal comprises cured adhesive.

Optionally, the receptacle connector complies with USB Type-C standard.

Some embodiments relate to a method of manufacturing a receptacle connector. The method may comprise providing first and second terminal subassemblies, each of the first and second terminal subassembly comprising a plurality of conductive elements held by a subassembly housing; assembling one of the first and second terminal subassemblies on a first side of a shielding member comprising inserting protrusions of the subassembly housing of the respective terminal subassembly into first holes of the shielding member; assembling the other one of the first and second terminal subassemblies on a second side of the shielding member comprising inserting protrusions of the subassembly housing of the respective terminal subassembly into second holes of the shielding member; and molding over the assembled first and second terminal subassemblies and the shielding member to form a terminal assembly.

Optionally, the method comprises assembling an inner shell on the housing of the terminal assembly comprising: fitting protrusions of the housing into openings of the inner shell; and engaging latches of the inner shell with the housing.

Optionally, the method comprises assembling a main shell outside the inner shell and the terminal assembly; assembling an outer shell outside the main shell; and forming a seal between mating ends of the main shell and the outer shell by applying an adhesive and curing the adhesive.

Some embodiments relate to a receptable connector. The receptacle connector comprising: a terminal assembly comprising a plurality of electrically conductive elements and an housing for accommodating the electrically conductive elements, the housing molded over the electrically conductive elements; an inner shell sleeved on at least a portion of an outer side of the housing; a main shell attached to an outer side of the inner shell and the terminal assembly; an outer shell attached to an outer side of the main shell, a mating end of the main shell extending beyond a mating end of the outer shell in a mating direction in which the receptacle connector is connected with a corresponding plug connector; and a sealing member attached to the portion of an outer sidewall of the main shell extending beyond the mating end of the outer shell, characterized in that the housing comprises a first connecting portion connected to the inner shell, the first connecting portion is provided adjacent to a rear end of the main shell and comprises a first engaging portion, the inner shell comprises a second engaging portion engaged with the first engaging portion, and the second engaging portion is formed integrally with the inner shell.

Optionally, the inner shell comprises a cylindrical portion, an inner circumferential contour shape of the cylindrical portion is at least partially adapted to an outer circumferential contour shape of the first connecting portion, the cylindrical portion comprises a first sidewall and a second sidewall facing toward the first sidewall in a thickness direction perpendicular to the mating direction of the receptacle connector, and the second engaging portion is provided on the first sidewall and/or the second sidewall.

Optionally, the second engaging portion of the inner shell comprises a first latch and a second latch which are configured to overhang from the first sidewall of the inner shell, the first engaging portion of the first connecting portion comprises a first recess cooperating with the first latch and a second recess cooperating with the second latch, and the first recess and the second recess are open towards the inner shell in the thickness direction, wherein a first distal end of the first latch and a second distal end of the second latch extend towards an inner side of the inner shell and are received in the first recess and the second recess, respectively, when the inner shell is assembled with the first connecting portion.

Optionally, the second engaging portion of the inner shell comprises a third latch and a fourth latch which are configured to overhang from the second sidewall of the inner shell, the first engaging portion of the first connecting portion comprises a third recess cooperating with the third latch and a fourth recess cooperating with the fourth latch, and the third recess and the fourth recess are open towards the inner shell in the thickness direction, wherein a third distal end of the third latch and a fourth distal end of the fourth latch extend towards an inner side of the inner shell and are received in the third recess and the fourth recess, respectively, when the inner shell is assembled with the first connecting portion.

Optionally, the housing comprises a second connecting portion connected with the first connecting portion, the second connecting portion is arranged in the mating direction to be closer to a mating end of the housing than the first connecting portion in the mating direction, and in a projection plane of the housing perpendicular to the mating direction, an outer contour shape of the first connecting portion is larger than an outer contour shape of the second connecting portion, and the second connecting portion comprises a protrusion extending outwardly from an outer surface of the housing, and the inner shell comprises a bore for engaging with the protrusion.

Optionally, the cylindrical portion comprises a flange having an annular shape, the flange of the cylindrical portion extends in a plane perpendicular to the mating direction, the inner shell comprises a first extension and a second extension, the first extension and the second extension both are connected with the flange of the cylindrical portion and extend from the flange of the cylindrical portion in a plane perpendicular to the thickness direction, and the first extension and the second extension are provided on opposite sides of the second connecting portion of the housing in the thickness direction.

Optionally, the first extension, the second extension and the cylindrical portion are formed as an integral shielding metal member, and each of the first extension and the second extension fits with at least a portion of an outer circumferential surface of the second connecting portion of the housing.

Optionally, the protrusion has an L-shaped shape in a cross-section perpendicular to a width direction of the receptacle connector, the width direction is perpendicular to both the mating direction and the thickness direction, and the protrusion is arranged at a connecting portion where the first connecting portion is connected with the second connecting portion, wherein at least one portion of the bore of the inner shell is provided on the first extension and/or the second extension, and the other portion of the bore of the inner shell is provided on the flange of the cylindrical portion.

Optionally, the housing comprises a third connecting portion which is provided on the side of the first connecting portion that is opposite to the second connecting portion and is located adjacent to a rear end of the housing, and in a projection plane of the housing perpendicular to the mating direction, an outer contour shape of the third connecting portion is larger than an outer contour shape of the first connecting portion such that at least a portion of a rear end surface of the main shell and a rear end surface of the outer shell abuts against a mating end of the third connecting portion.

Optionally, the plurality of electrically conductive elements comprises a first plurality of electrically conductive elements and a second plurality of electrically conductive elements, the first plurality of electrically conductive elements and the second plurality of electrically conductive elements are arranged in rows in a width direction of the receptacle connector, respectively, and the first plurality of electrically conductive elements and the second plurality of electrically conductive elements are spaced apart from each other in a thickness direction of the receptacle connector perpendicular to the width direction, and the terminal assembly further comprises a shielding member provided between the first plurality of electrically conductive elements and the second plurality of electrically conductive elements in the thickness direction.

With the receptacle connector according to an exemplary embodiment of the present application, by providing a shielding member between the first plurality of electrically conductive elements and the second plurality of electrically conductive elements, the signal crosstalk between the first plurality of electrically conductive elements and the second plurality of electrically conductive elements can be efficiently shielded to achieve a faster data transmission speed.

Optionally, the first plurality of electrically conductive elements and the second plurality of electrically conductive elements are arranged to be symmetrical with respect to a mid-plane of the shielding member perpendicular to the thickness direction.

Optionally, the terminal assembly comprises a first subassembly and a second subassembly, the first subassembly comprises the first plurality of electrically conductive elements and a first subassembly housing for accommodating the first plurality of electrically conductive elements, and the second subassembly comprises the second plurality of electrically conductive elements and a second subassembly housing for accommodating the second plurality of electrically conductive elements, and the shielding member comprises a first plurality of holes and a second plurality of holes, the first subassembly housing comprises a first plurality of protrusions configured to pass through the first plurality of holes of the shielding member and extend towards the second subassembly housing, and the second subassembly housing comprises a second plurality of protrusions configured to pass through the second plurality of holes of the shielding member and extend towards the first subassembly housing.

Optionally, the first plurality of holes of the shielding member comprises a first hole and a second hole, the first plurality of protrusions of the first subassembly housing comprises a first protrusion configured to extend through the first hole of the shielding member and a second protrusion configured to extend through the second hole of the shielding member, and the second subassembly housing comprises a first recess corresponding to the first protrusion and a second recess corresponding to the second protrusion, when the first subassembly, the shielding member and the second subassembly are assembled, the first protrusion of the first subassembly extends through the first hole of the shielding member and is received in the first recess of the second subassembly, and the second protrusion of the first subassembly extends through the second hole of the shielding member and is received in the second recess of the second subassembly.

Optionally, the second plurality of holes of the shielding member comprises a third hole and a fourth hole, the second plurality of protrusions of the second subassembly housing comprises a third protrusion configured to extend through the third hole of the shielding member and a fourth protrusion configured to extend through the fourth hole of the shielding member, and the first subassembly comprises a third recess corresponding to the third protrusion and a fourth recess corresponding to the fourth protrusion, when the first subassembly, the shielding member and the second subassembly are assembled, the third protrusion of the second subassembly extends through the third hole of the shielding member and is received in the third recess of the first subassembly, and the fourth protrusion of the second subassembly extends through the fourth hole of the shielding member and is received in the fourth recess of the first subassembly.

Optionally, each of the first protrusion, the second protrusion, the third protrusion, and the fourth protrusion is engaged with a corresponding hole in an interference-fit manner.

Optionally, each of the first protrusion, the second protrusion, the third protrusion, and the fourth protrusion comprises a body extending in the thickness direction and a plurality of projections protruding radially outward from the body, and each of the first hole, the second hole, the third hole and the fourth hole of the shielding member is formed as a cylindrical hole, with a circumferential outer surface of the projections fitting closely with an inner surface of the corresponding hole.

Optionally, the first protrusion, the second protrusion, the third recess and the fourth recess of the first subassembly housing are arranged in a quadrilateral array, wherein the first protrusion and the second protrusion are arranged in a first diagonal of the quadrilateral array, and the third recess and the fourth recess are arranged on a second diagonal of the quadrilateral array intersecting with the first diagonal.

Optionally, a flange portion is provided at a mating end of the outer shell, the flange portion comprises an annular flange portion proximal surface extending in a plane perpendicular to the mating direction, a first rough portion is provided on the flange portion proximal surface of the outer shell, and the sealing member is provided to rest against the flange portion proximal surface of the outer shell and is attached to the first rough portion.

With the receptacle connector according to the present application, the flange portion of the outer shell of the receptacle connector provided with the first rough portion has a surface roughness higher than a surface roughness of remaining portions of the outer shell, thereby significantly improving an adhesion force between the sealing member and the rough portion of the flange portion of the outer shell. The sealing member is firmly attached to the outer shell, effectively avoiding the sealing member from falling off, thus significantly improving the waterproof efficiency and service life of the receptacle connector.

Optionally, a second rough portion is provided on a portion of an outer sidewall of the main shell extending beyond a mating end of the outer shell, and the sealing member is attached to the second rough portion.

Optionally, each of the first rough portion and the second rough portion comprises a pattern formed by at least one of a diagonal pattern, a grid pattern, or a predetermined symbol pattern.

Optionally, the predetermined symbol pattern comprises at least one of a starlike shape, an H shape, or an X shape.

Optionally, a size of the sealing member in the mating direction is set in a range of 0.1 mm to 5 mm.

Optionally, the receptacle connector is mounted in an electrical device, the sealing member is an elastically deformable member, and the sealing member is configured to elastically deform when the sealing member is in contact with the mounting portion of the electronic device, so to form an interference fit with the mounting portion of the electronic device in a direction perpendicular to the mating direction.

Optionally, the sealing member is configured to have an annular shape extending circumferentially and continuously around a mating end of the main shell, and the sealing member is configured to have an attachment surface forming a shape-and-position fit (a positive fit) with an outer sidewall of the main shell and the flange portion proximal surface of the outer shell.

These techniques may be used alone or in any suitable combination. The foregoing summaries are provided by way of illustration and are not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an exemplary receptacle connector, according to some embodiments.

FIG. 2 is a partially exploded perspective view of the receptacle connector of FIG. 1, according to some embodiments.

FIG. 3 is a perspective view of a terminal assembly of the receptacle connector of FIG. 1, according to some embodiments.

FIG. 4 is a side view of the terminal assembly of FIG. 3, according to some embodiments.

FIG. 5 is a perspective view of an inner shell of the receptacle connector of FIG. 1, according to some embodiments.

FIG. 6 is another perspective view of the inner shell of FIG. 5, according to some embodiments.

FIG. 7 is a top view of the terminal assembly of FIG. 3 attached with the inner shell of FIG. 5, according to some embodiments.

FIG. 8 is cross-sectional view of the assembly of FIG. 7, taken along a line marked “A-A” in FIG. 7, according to some embodiments.

FIG. 9 is a perspective view of the receptacle connector of FIG. 1, with the outer shell and the sealing member hidden, according to some embodiments.

FIG. 10 is a perspective view of the receptacle connector of FIG. 1, with the sealing member hidden, according to some embodiments.

FIG. 11 is a perspective view of the receptacle connector of FIG. 1, showing two rows of conductive elements and a shielding member disposed in between and with other components hidden, according to some embodiments.

FIG. 12 is a perspective view of the receptacle connector of FIG. 1, showing a second molding over first and second subassemblies and the shielding member disposed in between to form the terminal subassembly of FIG. 3 and with other components hidden, according to some embodiments.

FIG. 13 is a perspective view of the first subassembly and shielding member of the receptacle connector of FIG. 12, according to some embodiments.

FIG. 14 is a partially exploded perspective view of the receptacle connector of FIG. 12, showing the first subassembly, the shielding member, and the second subassembly, according to some embodiments.

### DETAILED DESCRIPTION

The inventors have recognized and appreciated techniques for making reliable receptacle connectors. A receptacle connector may be integrated inside a chassis of an electronic device and configured to receive a mating component such as a plug connector to enable the electronic device to connect with other devices. For example, USB Type-C connectors are used in various electronic devices such as cell phones, smart watches, tablet PCs, photographic equipment, game consoles, routers, electric pens, electronic cigarettes, portable monitoring devices, etc. The force applied to insert and/or remove mating components may lead to movements among the components of the receiving receptacle connectors, causing unreliable connections and/or inefficient shielding.

Techniques described herein enable more reliable receptacle connectors. Such techniques are illustrated herein as applied to a USB Type-C vertical receptacle connector. According to aspects of the present disclosure, a receptacle connector may include a terminal assembly having conductive elements held by a housing. Each conductive element may have a mating end held by a tongue of the housing, a tail end extending outside the housing, and an intermediate portion partially held by portions of the housing that have different contours. The terminal assembly can be formed by assembling terminal subassemblies on opposite sides of a shield and molding over the assembly to form the housing. The shield may have holes disposed in an array. Each terminal subassembly may have protrusions disposed at locations corresponding to respective holes in the array such that the terminal subassemblies can be assembled to opposite sides of the shield. The assembled terminal subassemblies and shield may be molded over to form the terminal assembly. Techniques described herein may reduce the complexity of manufacturing a terminal assembly by assembling and overmolding similar or identical terminal subassemblies.

An inner shell may be sleeved on the housing and engage with both portions of the housing that have different contours. In some embodiments, the inner shell may include a first portion substantially conforming to a first portion of the housing, a flange extending from the first portion of the inner shell, and a second portion extending from the flange and disposed on a second portion of the housing that has a smaller contour than the first portion of the housing. A main shell may be sleeved on the inner shell. An outer shell may be sleeved on the main shell and shaped such that a seal can be formed between the shells. Techniques described herein may enable distributing forces to mate/unmate the connector from the shells to the housing and therefore reduce relevant movements between the components of the connector.

Next, exemplary embodiments of the receptacle connector according to the present application will be described in detail with reference to the accompanying drawings. For a clear and concise description, a mating direction Y, a width direction X and a thickness direction Z may be labeled in the figure. The mating direction Y, the width direction X and the thickness direction Z may be perpendicular to one another. The mating direction Y may refer to a direction in which the receptacle connector is to connect with a corresponding plug connector. The width direction X may refer to a width direction of the receptacle connector. The thickness direction Z may refer to a height direction of the receptacle connector.

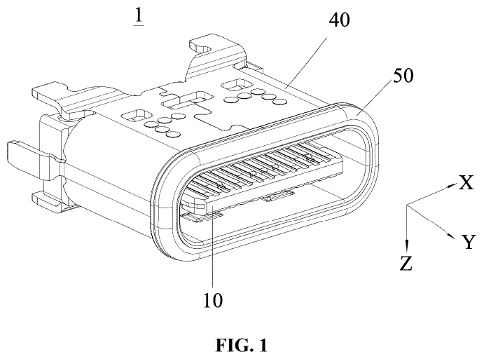

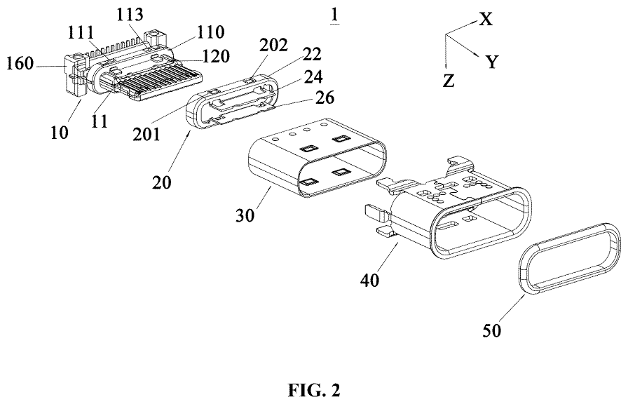

Referring to FIGS. 1-2, these figures illustrate a receptacle connector 1 according to an exemplary embodiment of the present application. Optionally, a receptacle connector according to the present application may be a USB Type-C receptacle electrical connector for an electrical device. An electronic device implements charging thereof, or data exchange with other electronic devices, by connecting a USB receptacle connector with an adaptable USB plug connector.

As shown in FIG. 1 and FIG. 2, the receptacle connector 1 may comprise: a terminal assembly 10 comprising a plurality of electrically conductive elements and an housing 11 for accommodating the electrically conductive elements, the housing 11 molded over the electrically conductive elements; an inner shell 20 sleeved on at least a portion of an outer side of the housing 11; a main shell 30 attached to an outer side of the inner shell 20 and the terminal assembly 10; an outer shell 40 attached to an outer side of the main shell 30, a mating end of the main shell 30 extending beyond a mating end of the outer shell 40 in a mating direction Y in which the receptacle connector is connected with a corresponding plug connector; and a sealing member 50 attached to the portion of an outer sidewall of the main shell 30 extending beyond the mating end of the outer shell 40. The housing 11 may comprise a first connecting portion 110 connected to the inner shell 20, the first connecting portion 110 is provided adjacent to a rear end of the main shell 30 and comprises a first engaging portion. The inner shell 20 may comprise a second engaging portion configured to engage with the first engaging portion. The second engaging portion may be formed integrally with the inner shell 20.

With the receptacle connector according to an exemplary embodiment of the present application, the second engaging portion of the inner shell 20 is engaged with the first engaging portion provided on the first connecting portion 110 of the housing 11 of the terminal assembly 10 so that the inner shell is fixed with respect to the housing of the terminal assembly, thereby effectively reduce the risk of the inner shell shifting with respect to the terminal assembly along the mating direction Y. With this configuration, a force transfer path from the inner shell 20 toward the housing is provided, thereby reducing the force transferred from the mating portion of the plug connector to the soldering pin of the outer shell of the receptacle connector through the inner shell 20 of the receptacle connector, when a user plugs or unplug the mating plug connector. For example, when a user plugs the mating portion of the plug connector to the receptacle connector by a large force, the force transferred to the soldering pin of the outer shell of the receptacle connector can be effectively reduced, thus reducing the risk of accidental separation of the soldering pin of the outer shell of the receptacle connector from the printed circuit board under the action of a large mating force.

The inner shell according to the present application comprises an engaging portion formed integrally with the inner shell, for example, the engaging portion is part of the inner shell, such that the inner shell may be attached to the terminal assembly without additional attachment components. Such a configuration may reduce the number of components of the receptacle connector, and simplify the manufacturing process, enabling a compact structure while also improving the durability of the receptacle connector. Thus the contact stability and the connection reliability between the plug connector and the receptacle connector are improved. The inner shell may be fixed effectively with respect to the terminal assembly. The risk of misaligning or undesirably shifting the inner shell of the receptacle connector with respect to the terminal assembly due to frequent plugging and removal of the mating portion of the plug connector may be reduced. Alternatively or additionally, a sealing member 50 may be provided to form a seal between the main shell and the mounting portion of the electronic device, blocking water or dust from entering through the socket of the USB Type-C receptacle connector to the interior of the electronic device, reducing the risk of a short circuit inside the electronic device, and improving safety performance.

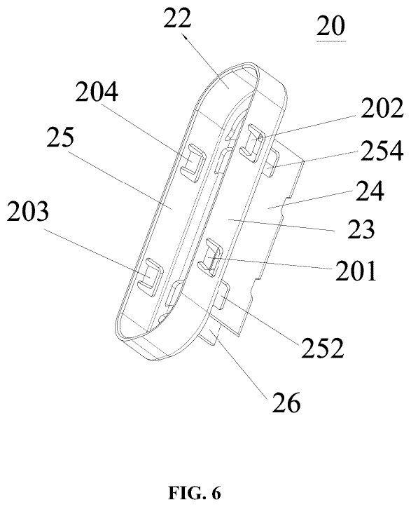

In some exemplary embodiments, as shown in FIG. 5 and FIG. 6, the inner shell 20 comprises a cylindrical portion 22, an inner circumferential contour shape of the cylindrical portion 22 is at least partially adapted to an outer circumferential contour shape of the first connecting portion 110. The cylindrical portion 22 comprises a first sidewall 23 and a second sidewall 25 facing the first sidewall 23 in a thickness direction Z perpendicular to the mating direction Y of the receptacle connector 1, and the second engaging portion is provided on the first sidewall 23 and/or the second sidewall 25.

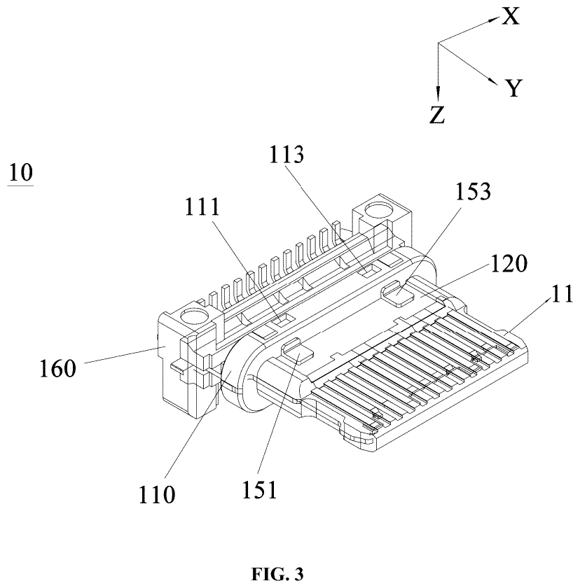

As shown in FIGS. 3-8, the second engaging portion of the inner shell 20 may comprise a first latch 201 and a second latch 202 configured to overhang from the first sidewall 23 of the inner shell 20. The first engaging portion of the first connecting portion 110 comprises a first recess 111 cooperating with the first latch 201 and a second recess 113 cooperating with the second latch 202, and the first recess 111 and the second recess 113 are open towards the inner shell 20 in the thickness direction Z.

A first distal end of the first latch 201 and a second distal end of the second latch 202 extend towards an inner side of the inner shell 20 and are received in the first recess 111 and the second recess 113, respectively, when the inner shell 20 is assembled with the first connecting portion 110.

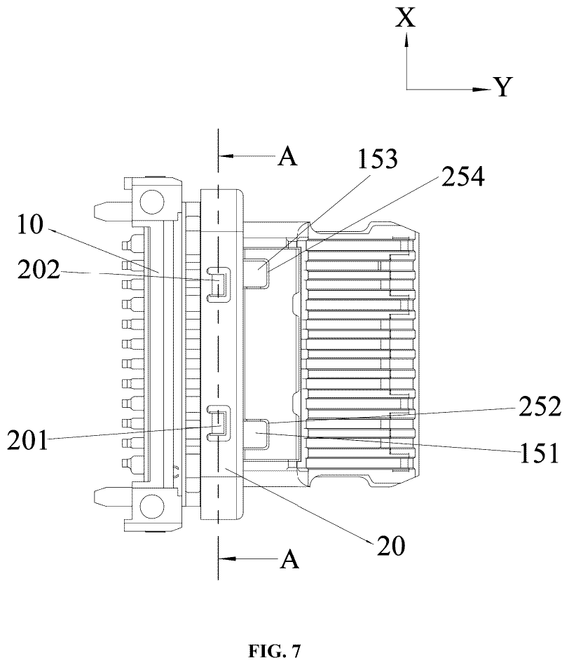

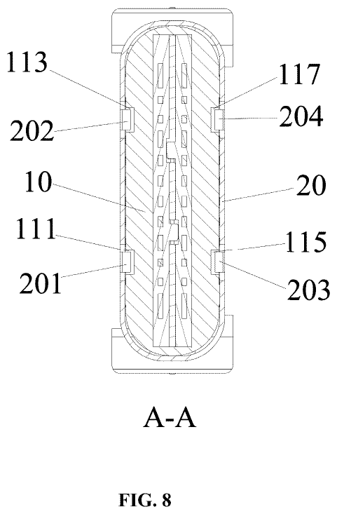

As shown in FIG. 7 and FIG. 8, the second engaging portion of the inner shell 20 may further comprise a third latch 203 and a fourth latch 204 which are configured to overhang from the second sidewall 25 of the inner shell 20, the first engaging portion of the first connecting portion 110 comprises a third recess 115 cooperating with the third latch 203 and a fourth recess 117 cooperating with the fourth latch 204, and the third recess 115 and the fourth recess 117 are open towards the inner shell 20 in the thickness direction Z. A third distal end of the third latch 203 and a fourth distal end of the fourth latch 204 extend towards an inner side of the inner shell 20 and are disposed in the third recess 115 and the fourth recess 117, respectively, when the inner shell 20 is assembled with the first connecting portion 110.

As shown in FIGS. 5-8, the first latch 201 may be an overhanging portion formed by cutting a continuous slit in the first sidewall 23 of the cylindrical portion 22. The first latch 201 may be formed to have a substantially rectangular shape. In some optional embodiments, the first latch 201 may be formed to have the following shapes: semicircular, trapezoidal, irregularly shaped, and the like. Alternatively or additionally, the first latch 201, the second latch 202, the third latch 203, and the fourth latch 204 are formed to have the same size and shape.

In some examples, a size of the first latch 201 in the mating direction Y is provided to be smaller than a size of the cylindrical portion 22 in the mating direction Y. Optionally, the size of the first latch 201 in the mating direction Y is half the size of the cylindrical portion 22 in the mating direction Y.

It should be understood that the number, the size, the location and the arrangement of the latch and the recess may not be limited to the specific embodiment shown, and may be adjusted according to specific implementations. Further, the second engaging portion of the inner shell 20 of the present application and the first engaging portion provided on the first connecting portion 110 of the housing 11 of the terminal assembly 10 may be connected in a snap fit manner to keep the inner shell 20 fixed with respect to the housing 11 of the terminal assembly 10.

In some other examples, one of the second engaging portion of the inner shell 20 and the first engaging portion of the housing 11 may be provided as an opening, and the other of the second engaging portion of the inner shell 20 and the first engaging portion of the housing 11 may be provided as a protrusion that cooperates with the opening to reduce the risk of relative movements between the inner shell 20 and the housing 11 of the terminal assembly 10.

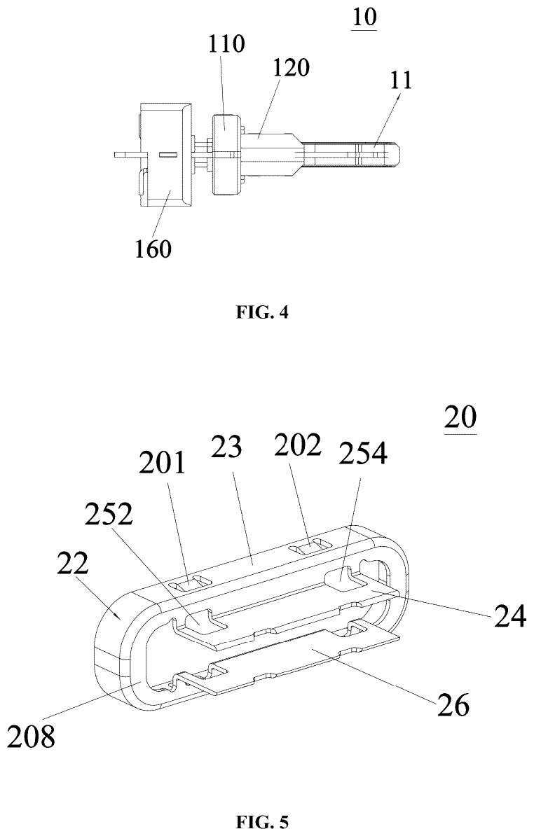

In some exemplary embodiments, as shown in FIG. 3 and FIG. 4, the housing 11 comprises a second connecting portion 120 extending from the first connecting portion 110, and the second connecting portion is arranged to be closer to a mating end of the housing 11 than the first connecting portion 110 in the mating direction Y. In a projection plane of the housing 11 perpendicular to the mating direction Y, an outer contour shape of the first connecting portion 110 is larger than an outer contour shape of the second connecting portion 120.

The second connecting portion 120 may comprise a protrusion 151, 153 extending outwardly from an outer surface of the housing 11, and the inner shell 20 may comprise a bore 252, 254 configured to engage with the protrusion 151, 153 respectively.

As shown in FIG. 5, the cylindrical portion 22 may comprise a flange 208 having an annular shape. The flange 208 of the cylindrical portion 22 extends in a plane perpendicular to the mating direction Y from a circumferential sidewall of the cylindrical portion 22 towards a longitudinal central axis of the cylindrical portion 22, where the longitudinal central axis of the cylindrical portion 22 has an extending direction consistent with the mating direction Y. The inner shell 20 further comprises a first extension 24 and a second extension 26. The first extension 24 and the second extension 26 both are connected with the flange of the cylindrical portion 22 and extend from the flange of the cylindrical portion 22 in a plane perpendicular to the thickness direction Z, and the first extension 24 and the second extension 26 are provided on opposite sides of the second connecting portion 120 of the housing 11 in the thickness direction Z.

In some exemplary embodiments, the first extension 24, the second extension 26 and the cylindrical portion 22 may be formed integrally, for example, formed as an integral shielding metal member. Each of the first extension 24 and the second extension 26 fits with at least a portion of an outer circumferential surface of the second connecting portion 120 of the housing 11.

In some exemplary embodiments, the inner shell 20 serves as an integral shielding metal member, e.g., as an internal EMC pad for the receptacle connector 1 to absorb and dissipate electromagnetic interference (EMI), thereby protecting the receptacle connector from EMI. In some examples, the inner shell 20 may be made of an electrically conductive material. The receptacle connector 1 of the present application complies with the Universal Serial Bus Type-C Cable and Connector Specification as to EMC pads for receptacle connectors, and achieves reliable shielding against electromagnetic interference.

In some exemplary embodiments, as shown in FIG. 3, the protrusion 151, 153 of the second connecting portion 120 has an L-shaped shape in a cross-section perpendicular to a width direction X of the receptacle connector. The width direction X is perpendicular to both the mating direction Y and the thickness direction Z. The protrusion 151, 153 is arranged at a connecting portion where the first connecting portion 110 is connected with the second connecting portion 120. At least one portion of the bore of the inner shell 20 is provided on the first extension 24 and/or the second extension 26, and the other portion of the bore of the inner shell 20 is provided on the flange 208 of the cylindrical portion 22.

It should be understood that the number, size, location and arrangement of the protrusion of the second connecting portion 120 and the bore of the inner shell 20 may not be limited to the specific embodiment shown, and may be adjusted according to specific implementations.

In some exemplary embodiments, as shown in FIG. 3 and FIG. 4, the housing 11 may comprise a third connecting portion 160 which is provided on a side of the first connecting portion 110 that is opposite to the second connecting portion 120 and is located adjacent to a rear end of the housing 11. In a projection plane of the housing 11 perpendicular to the mating direction Y, an outer contour shape of the third connecting portion 160 is larger than an outer contour shape of the first connecting portion 110 such that at least a portion of a rear end surface of the main shell 30 and a rear end surface of the outer shell 40 abuts against a mating end of the third connecting portion 160.

In an exemplary embodiment according to the present application, by providing the third connecting portion, when the terminal assembly 10, the main shell 30, and the outer shell 40 are assembled, the main shell 30 and the outer shell 40 are positioned to abut against the third connecting portion of the terminal assembly 10 at a rear end, which facilitates limiting the position of the rear end surface of the main shell 30 and the rear end surface of the outer shell 40. Thus, the precision of the assembly is improved, the stability and reliability of the receptacle connector is ensured, the manufacturing process is simplified, and the efficiency of the assembly is improved.

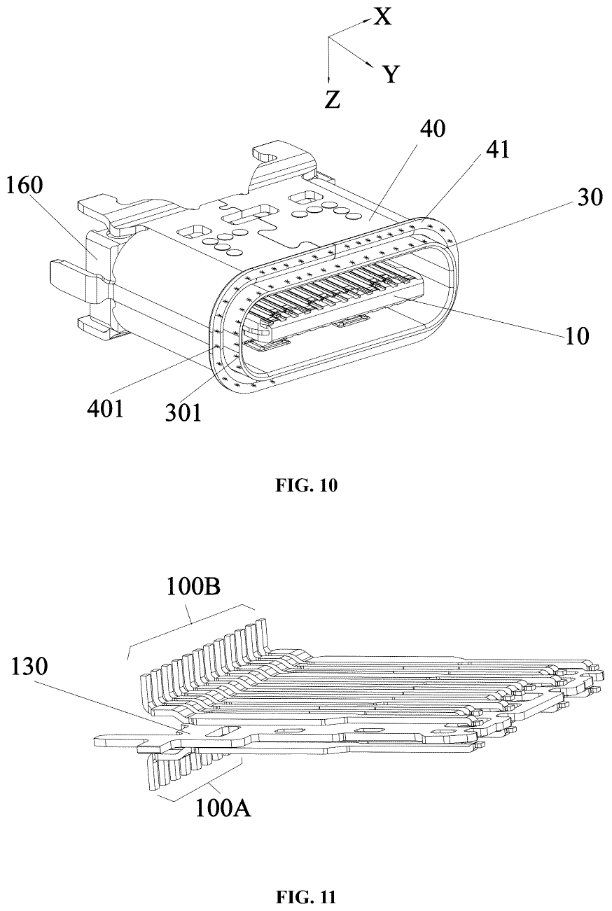

In some exemplary embodiments of the present application, as shown in FIG. 10, a flange portion 41 is provided at a mating end of the outer shell 40, and the flange portion 41 comprises an annular flange portion proximal surface extending in a plane perpendicular to the mating direction Y. A first rough portion 401 is provided on the flange portion proximal surface of the outer shell 40, and the sealing member 50 is provided to rest against the flange portion proximal surface of the outer shell 40 and is attached to the first rough portion 401.

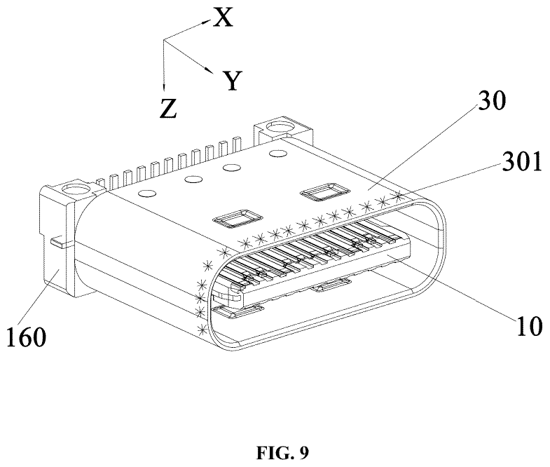

As shown in FIG. 9 and FIG. 10, a second rough portion 301 may be provided on a portion of an outer sidewall of the main shell 30 extending beyond a mating end of the outer shell 40, and the sealing member 50 is attached to the second rough portion 301.

The receptacle connector according to an exemplary embodiment of the present application can provide a very tight attachment between the sealing member 50 and the main shell 30 and the outer shell 40. By providing the first rough portion 401 on the flange portion 41 of the outer shell 40 of the receptacle connector 1 and by providing the second rough portion 301 on the main shell 30, the adhesion force between the sealing member 50 and the corresponding rough portion is significantly improved, and the sealing member 50 is effectively avoided from falling off. Therefore, a seamless seal can be created between the receptacle connector 1 and the mounting portion (for example a chassis) of the electronic device when mounting the receptacle connector 1 to the mounting portion of the electronic device to effectively prevent water vapor/dust from entering inside the electronic device.

In some examples, each of the first rough portion 401 and the second rough portion 301 comprises a pattern formed by at least one of a diagonal pattern, a grid pattern, or a predetermined symbol pattern. For example, the predetermined symbol pattern comprises at least one of a starlike shape, an H shape, or an X shape.

In some exemplary embodiments according to the present application, a size of the scaling member 50 in the mating direction Y may be set in a range of 0.1 mm to 5 mm. In some optional embodiments according to the present application, the sealing member 50 may have a size of 0.65 mm in the mating direction Y. Optionally, the sealing member 50 may have a size of 1.0 mm in the mating direction Y.

In some exemplary embodiments according to the present application, the receptacle connector 1 is mounted in an electrical device, and the sealing member 50 is an elastically deformable member and the sealing member 50 is configured to elastically deform when the scaling member 50 is in contact with the mounting portion of the electronic device, so as to form an interference fit with the mounting portion of the electronic device in a direction perpendicular to the mating direction Y. In one example, the sealing member may be made of ultraviolet light-curable adhesive (UV adhesive), silicone, or epoxy resin adhesive. Ultraviolet light-curable adhesive is rapidly cured into an elastic adhesive film under UV light irradiation, and is characterized by high adhesive strength, vibration resistance, high temperature resistance, and good durability, etc.

The sealing member 50 may be configured to have an annular shape extending circumferentially and continuously around a mating end of the main shell 30 (as shown in FIGS. 1 and 2). The sealing member 50 may be configured to have an attachment surface forming a shape-and-position fit (a positive fit) with an outer sidewall of the main shell 30 and the flange portion proximal surface of the outer shell 40. The sealing member 50 may be provided with a chamfered portion at a mating end along the mating direction Y so as to facilitate cooperation of the sealing member 50 with the mounting portion of the electronic device.

The term “a shape-and-position fit (a positive fit)” used in the present application may refer to a relationship in which two mating components are abutting against and tightly fit with each other in terms of the shape and the position.

In some exemplary embodiments of the present application, as shown in FIG. 11, the plurality of electrically conductive elements may comprise a first plurality of electrically conductive elements 100A and a second plurality of electrically conductive elements 100B, and the first plurality of electrically conductive elements 100A and the second plurality of electrically conductive elements 100B are arranged in rows in a width direction X of the receptacle connector, respectively. The first plurality of electrically conductive elements 100A and the second plurality of electrically conductive elements 100B are spaced apart from each other in a thickness direction Z of the receptacle connector 1 perpendicular to the width direction X. The terminal assembly 10 further comprises a shielding member 130 provided between the first plurality of electrically conductive elements 100A and the second plurality of electrically conductive elements 100B in the thickness direction Z.

With the receptacle connector according to an exemplary embodiment of the present application, by providing a shielding member between the first plurality of electrically conductive elements and the second plurality of electrically conductive elements, the overall structural strength of the terminal assembly can be improved, and electromagnetic interference signals emitted by the electrically conductive elements of one of the first plurality of electrically conductive elements and the second plurality of electrically conductive elements can be efficiently shielded with respect to the other one of the first plurality of electrically conductive elements and the second plurality of electrically conductive elements.

In some exemplary embodiments according to the present application, the first plurality of electrically conductive elements 100A and the second plurality of electrically conductive elements 100B are arranged to be symmetrical with respect to a mid-plane of the shielding member 130 perpendicular to the thickness direction Z. In some embodiments, the shielding member 130 may be made of a metal material, such as an iron-carbon alloy. In an optional embodiment, the shielding member 130 may be formed by stamping a metal sheet.

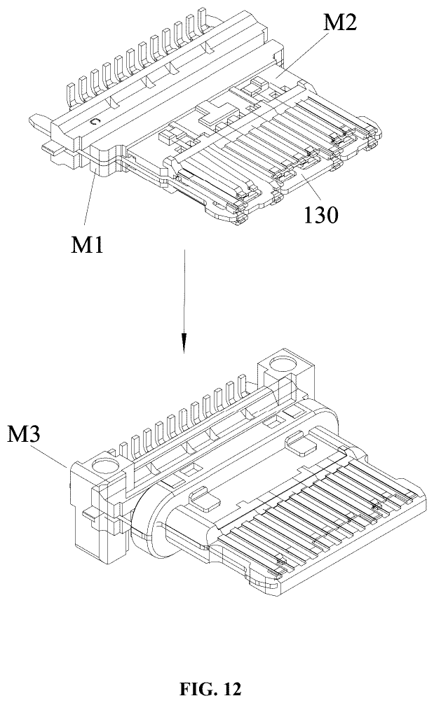

In some exemplary embodiments of the present application, as shown in FIG. 12, the terminal assembly 10 may comprise a first subassembly M1 and a second subassembly M2, and the first subassembly M1 comprises a first plurality of electrically conductive elements 100A and a first subassembly housing for accommodating the first plurality of electrically conductive elements 100A. The second subassembly M2 comprises a second plurality of electrically conductive elements 100B and a second subassembly housing for accommodating the second plurality of electrically conductive elements. The shielding member 130 comprises a first plurality of holes and a second plurality of holes, the first subassembly housing comprises a first plurality of protrusions configured to extend through the first plurality of holes of the shielding member 130 and towards the second subassembly housing, and the second subassembly housing comprises a second plurality of protrusions configured to extend through the second plurality of holes of the shielding member 130 and towards the first subassembly housing.

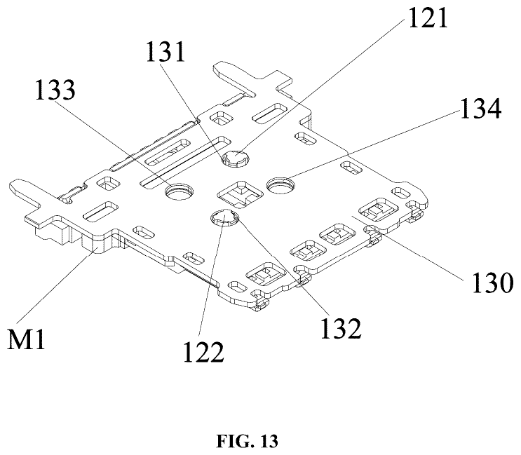

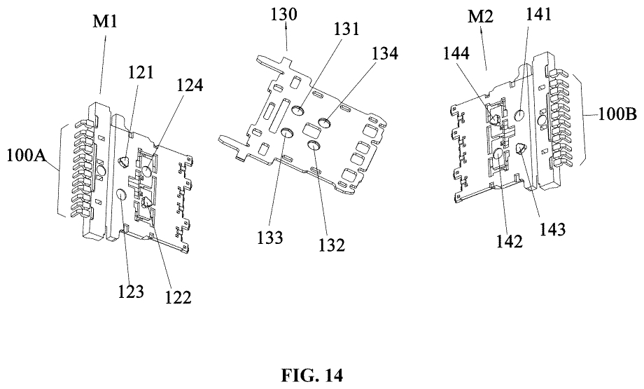

In some examples, as shown in FIG. 13 and FIG. 14, the first plurality of holes of the shielding member 130 comprises a first hole 131 and a second hole 132, and the first plurality of protrusions of the first subassembly housing comprises a first protrusion 121 configured to extend through the first hole 131 of the shielding member 130 and a second protrusion 122 configured to extend through the second hole 132 of the shielding member 130. The second subassembly housing comprises a first recess 141 corresponding to the first protrusion 121 and a second recess 142 corresponding to the second protrusion 122.

In some examples, when the first subassembly M1, the shielding member 130 and the second subassembly M2 are assembled, the first protrusion 121 of the first subassembly M1 extends through the first hole 131 of the shielding member 130 and is received in the first recess 141 of the second subassembly M2. The second protrusion 122 of the first subassembly M1 extends through the second hole 132 of the shielding member 130 and is received in the second recess 142 of the second subassembly M2.

As shown in FIG. 14, the second plurality of holes of the shielding member 130 may comprise a third hole 133 and a fourth hole 134, the second plurality of protrusions of the second subassembly housing comprises a third protrusion 143 configured to extend through the third hole 133 of the shielding member 130 and a fourth protrusion 144 configured to extend through the fourth hole 134 of the shielding member 130. The first subassembly M1 comprises a third recess 123 corresponding to the third protrusion 143 and a fourth recess 124 corresponding to the fourth protrusion 144.

In some examples, when the first subassembly M1, the shielding member 130 and the second subassembly M2 are assembled, the third protrusion 143 of the second subassembly M2 extends through the third hole 133 of the shielding member 130 and is disposed in the third recess 123 of the first subassembly M1. The fourth protrusion 144 of the second subassembly M2 extends through the fourth hole 134 of the shielding member 130 and is disposed in the fourth recess 124 of the first subassembly M1.

In some exemplary embodiments according to the present application, each of the first protrusion 121, the second protrusion 122, the third protrusion 143, and the fourth protrusion 144 is engaged with a corresponding hole in an interference-fit manner. In some examples, the protrusion and the corresponding hole are formed to have a desired fit tolerance.

In some exemplary embodiments according to the present application, as shown in FIG. 13 and FIG. 14, each of the first protrusion 121, the second protrusion 122, the third protrusion 143, and the fourth protrusion 144 comprises a body extending in the thickness direction and a plurality of projections protruding radially outward from the body. Each of the first hole 131, the second hole 132, the third hole 133 and the fourth hole 134 of the shielding member 130 is formed as a cylindrical hole, with a circumferential outer surface of the projections fitting closely with an inner surface of the corresponding hole.

The first protrusion 121, the second protrusion 122, the third recess 123 and the fourth recess 124 of the first subassembly housing are arranged in a quadrilateral array. The first protrusion 121 and the second protrusion 122 are arranged in a first diagonal of the quadrilateral array, and the third recess 123 and the fourth recess 124 are arranged on a second diagonal of the quadrilateral array intersecting with the first diagonal.

It should be understood that the number, the size, the location and the arrangement of the corresponding protrusions and recesses of the first subassembly housing of the first subassembly M1 and of the corresponding protrusions and recesses of the second subassembly housing of the second subassembly M2 may not be limited to the specific embodiment shown, and may be adjusted according to specific implementations. Further, the assembly mode of the first subassembly M1, the shielding member 130 and the second subassembly M2 of the present application may not be limited to thereto. For example, the first protrusion of the first subassembly M1 may be connected to the first recess of the second subassembly M2 by a snap fit, or they may be connected to each other by other suitable means.

By providing the protrusions and the recesses on the first subassembly housing of the first subassembly M1 and the second subassembly housing of the second subassembly M2, precise positioning of the first subassembly M1 and the second subassembly M2 can be realized, which can reduce the risk of manufacturing errors, save manufacturing time, and thus improve manufacturing efficiency.

In some exemplary embodiments according to the present application, a method of manufacturing a receptacle connector is provided. The method may comprise providing a terminal assembly 10 comprising a plurality of electrically conductive elements and a housing 11 for accommodating the electrically conductive elements, the housing 11 molded over the electrically conductive elements; providing an inner shell 20 sleeved on at least a portion of an outer side of the housing 11; providing a main shell 30 attached to an outer side of the inner shell 20 and the terminal assembly 10; providing an outer shell 40 attached to an outer side of the main shell 30, such that a mating end of the main shell 30 extends beyond a mating end of the outer shell 40 in a mating direction in which the receptacle connector is connected with a corresponding plug connector; and applying an adhesive along a circumferential direction of the main shell 30 at an outer sidewall of the mating end of the main shell 30 extending beyond the mating end of the outer shell 40, and curing the adhesive to form a sealing member 50 attached to the outer sidewall. Providing a terminal assembly 10 may comprises configuring the housing 11 to comprise a first connecting portion 110 connected to the inner shell 20, with the first connecting portion 110 provided adjacent to a rear end of the main shell 30 and comprising a first engaging portion.

Providing an inner shell may comprise configuring the inner shell 20 to comprise a second engaging portion engaged with the first engaging portion, where the second engaging portion is formed integrally with the inner shell 20 from a single blank.

In some exemplary embodiments according to the present application, providing the inner shell 20 may comprise: configuring the inner shell 20 to comprise a cylindrical portion 22, where an inner circumferential contour shape of the cylindrical portion 22 is at least partially adapted to an outer circumferential contour shape of the first connecting portion 110, configuring the cylindrical portion 22 to comprise a first sidewall 23 and a second sidewall 25 facing the first sidewall 23 in a thickness direction Z perpendicular to the mating direction Y of the receptacle connector, and forming a second engaging portion on the first sidewall 23 and/or the second sidewall 25 by a cutting process such that the second engaging portion is capable of bending toward the inner side of the cylindrical portion 22.

In some exemplary embodiments according to the present application, providing the inner shell 20 may comprise: configuring the second engaging portion of the inner shell 20 to comprise a first latch 201 and a second latch 202, which are configured to overhang from the first sidewall 23 of the inner shell 20.

Providing the housing 11 may comprise: configuring the first engaging portion of the first connecting portion 110 to comprise a first recess 111 cooperating with the first latch 201 and a second recess 113 cooperating with the second latch 202. When the inner shell 20 is not assembled with the first connecting portion 110, the first latch 201 and the second latch 202 extend along the first sidewall 23 of the inner shell 20. When the inner shell 20 is assembled with the first connecting portion 110, a first distal end of the first latch 201 and a second distal end of the second latch 202 extend towards an inner side of the inner shell 20 and are disposed in the first recess 111 and the second recess 113, respectively.

In some exemplary embodiments of the present application, providing an outer shell 40 may comprise: providing a flange portion 41 at a mating end of the outer shell 40, and the flange portion 41 comprises an annular flange portion proximal surface extending in a plane perpendicular to the mating direction Y.

Providing an outer shell 40 may comprise: roughening a flange portion proximal surface of the outer shell 40 by laser engraving processing or electrical discharge processing to form a first rough portion 401; or embossing or knurling a flange portion proximal surface of the outer shell 40 to form the first rough portion 401.

In some exemplary embodiments according to the present application, providing the main shell 30 may comprise: roughening a portion of an outer surface of the main shell 30 near its mating end by laser engraving processing or electrical discharge processing to form a second rough portion 301; or embossing or knurling a portion of the outer surface of the main shell 30 near its mating end to form the second rough portion 301.

Other processing methods can also be used to increase the surface roughness of corresponding portions of the outer surface of the main shell 30 and the flange portion proximal surface of the outer shell 40. For example, the corresponding surface of the main shell and the outer shell can be processed by using tools such as grinding wheels, cutting tools, etc., to obtain the desired roughness.

In some exemplary embodiments according to the present application, the method may further comprise: providing an adhesive forming tool that matches with the sealing member 50 in terms of a predetermined size and shape; placing the first rough portion 401 of the outer shell 40 and the second rough portion 301 provided on an outer surface of the main shell 30 in the adhesive forming tool; and applying an adhesive at the first rough portion 401 and the second rough portion 301 in a circumferential direction of the outer sidewall of the main shell. The adhesive is applied in the adhesive forming tool by one of the following: time and pressure type dispensing, piston pump dispensing, and screw metering pump dispensing.

In some exemplary embodiments, the adhesive forming tool houses an adhesive, which may be selected from one of the following: UV adhesive, silicone, epoxy resin adhesive. In some examples, the adhesive used to form the sealing member 50 may be underfill.

In some exemplary embodiments according to the present application, providing a terminal assembly 10 may comprise: forming the plurality of electrically conductive elements into a first plurality of electrically conductive elements 100A and a second plurality of electrically conductive elements 100B, and arranging the first plurality of electrically conductive elements 100A and the second plurality of electrically conductive elements 100B in rows in a width direction X of the receptacle connector, respectively, and arranging the first plurality of electrically conductive elements 100A and the second plurality of electrically conductive elements 100B to be spaced apart from each other in a thickness direction Z of the receptacle connector; providing a shielding member 130; and arranging the shielding member 130 between the first plurality of electrically conductive elements 100A and the second plurality of electrically conductive elements 100B in the thickness direction Z.

In some exemplary embodiments according to the present application, providing a terminal assembly may comprise: providing a plurality of electrically conductive elements; placing the plurality of electrically conductive elements in a first injection mold for injection molding to form a plurality of electrically conductive element molding members, the plurality of electrically conductive element molding members comprising first subassembly M1 and second subassembly M2 that are identical to each other, where the first subassembly M1 comprises a first plurality of electrically conductive elements 100A and a first subassembly housing for accommodating the first plurality of electrically conductive elements 100A, and the second subassembly M2 comprises a second plurality of electrically conductive elements 100B and a second subassembly housing for accommodating the second plurality of electrically conductive elements.

Providing a terminal assembly 30 may comprise: arranging the first subassembly M1 and the second subassembly M2 on opposite sides of the shielding member 130 in the thickness direction Z of the receptacle connector, such that the first plurality of electrically conductive elements 100A of the first subassembly M1 and the second plurality of electrically conductive elements 100B of the second subassembly M2 are symmetrical with each other about a mid-plane of the shielding member 130 perpendicular to the thickness direction.

Providing a terminal assembly 30 may comprise assembling the first subassembly M1, the shielding member 130, and the second subassembly M2 together and placing them in a second injection mold for injection molding to form a third subassembly M3 (shown in FIG. 12), and forming the terminal assembly 10 from the third subassembly M3.

With the method of manufacturing a receptacle connector provided according to the present application, a plurality of identical electrically conductive element molding members are injection molded in the first injection mold, two electrically conductive element molding members are selected from the plurality of electrically conductive element molding members to serve as the first subassembly M1 and the second subassembly M2, respectively, and then the first subassembly M1, the shielding member 130, and the second subassembly M2 are assembled together and placed in the second injection mold for injection molding to form the third subassembly M3. In the related art, the receptacle connector usually comprises two different sets of electrically conductive components, which need to be injection molded independently in different molds. In comparison, by the method of manufacturing the receptacle connector of the present application, the first subassembly M1 and the second subassembly M2 can be manufactured in a first injection mold in batch, thereby substantially reducing the injection molding duration, simplifying the manufacturing process, and improving the manufacturing efficiency.

In some exemplary embodiments according to the present application, providing the shielding member 130 may comprise: molding by stamping a shielding sheet material, and forming a first plurality of holes and a second plurality of holes on the shielding member 130.

Forming the electrically conductive element molding member may comprise forming a plurality of protrusions and a plurality of recesses on a side portion of the electrically conductive element molding member in a thickness direction.

Assembling the first subassembly M1, the shielding member 130, and the second subassembly M2 may comprise: inserting the protrusion of the electrically conductive element molding member as the first subassembly M1 through the first plurality of holes of the shielding member 130 and accommodating it in the corresponding recess of the second subassembly M2, and inserting the protrusion of the electrically conductive element molding member as the second subassembly M2 through the second plurality of holes of the shielding member 130 from a side of the shielding member 130 that is opposite to the first subassembly M1, and accommodating it in the corresponding recess of the first subassembly M1.

In some exemplary embodiments according to the present application, providing the shielding member may comprise: forming a first hole 131, a second hole 132, a third hole 133, and a fourth hole 134 in a quadrilateral array on the shielding member 130 (as shown in FIG. 14).

Forming the electrically conductive element molding member may comprise: configuring the first subassembly housing of the first subassembly M1 to comprise a first protrusion 121 configured to extend through the first hole 131 and a second protrusion 122 configured to extend through the second hole 132; and configuring the second subassembly housing of the second subassembly M2 to comprise a third protrusion 143 configured to extend through the third hole 133 and a fourth protrusion 144 configured to extend through the fourth hole 134.

Forming the electrically conductive element molding member may comprise: configuring the second subassembly housing of the second subassembly M2 to comprise a first recess 141 corresponding to the first protrusion 121 and a second recess 142 corresponding to the second protrusion 122; and configuring the first subassembly housing of the first subassembly M1 to comprise a third recess 123 corresponding to the third protrusion 143 and a fourth recess 124 corresponding to the fourth protrusion 144.

Assembling the first subassembly M1, the shielding member 130, and the second subassembly M2 together may comprise: extending the first protrusion 121 of the first subassembly M1 through the first hole 131 and accommodating the first protrusion 121 in the first recess 141 of the second subassembly M2, and extending the second protrusion 122 of the first subassembly M1 through the second hole 132 and accommodating the second protrusion 122 in the second recess 142 of the second subassembly M2, extending a third protrusion 143 of the second subassembly M2 through the third hole 133 and accommodating the third protrusion 143 in the third recess 123 of the first subassembly M1, and extending a fourth protrusion 144 of the second subassembly M2 through the fourth hole 134 and accommodating the fourth protrusion 144 in the fourth recess 124 of the first subassembly M1.

Various aspects are described in this disclosure, which include, but are not limited to, the following aspects:

1. A receptacle connector, the receptacle connector (e.g., 1) comprising: a terminal assembly (e.g., 10) comprising a plurality of electrically conductive elements and a housing (e.g., 11) for accommodating the electrically conductive elements, the housing (e.g., 11) molded over the electrically conductive elements; an inner shell (e.g., 20) sleeved on at least a portion of an outer side of the housing (e.g., 11); a main shell (e.g., 30) attached to an outer side of the inner shell (e.g., 20) and the terminal assembly (e.g., 10); an outer shell (e.g., 40) attached to an outer side of the main shell (e.g., 30), a mating end of the main shell (e.g., 30) extending beyond a mating end of the outer shell (e.g., 40) in a mating direction (e.g., Y) in which the receptacle connector is connected with a corresponding plug connector; and a sealing member (e.g., 50) attached to the portion of an outer sidewall of the main shell (e.g., 30) extending beyond the mating end of the outer shell (e.g., 40), wherein the housing (e.g., 11) comprises a first connecting portion (e.g., 110) connected to the inner shell (e.g., 20), the first connecting portion (e.g., 110) is provided adjacent to a rear end of the main shell (e.g., 30) and comprises a first engaging portion, the inner shell (e.g., 20) comprises a second engaging portion engaged with the first engaging portion, and the second engaging portion is formed integrally with the inner shell (e.g., 20).

2. The receptacle connector according to aspect 1 or any other aspect, wherein the inner shell (e.g., 20) comprises a cylindrical portion (e.g., 22), an inner circumferential contour shape of the cylindrical portion (e.g., 22) is at least partially adapted to an outer circumferential contour shape of the first connecting portion (e.g., 110), the cylindrical portion (e.g., 22) comprises a first sidewall (e.g., 23) and a second sidewall (e.g., 25) facing toward the first sidewall (e.g., 23) in a thickness direction (e.g., Z) perpendicular to the mating direction (e.g., Y) of the receptacle connector, and the second engaging portion is provided on the first sidewall (e.g., 23) and/or the second sidewall (e.g., 25).

3. The receptacle connector according to aspect 2 or any other aspect, wherein the second engaging portion of the inner shell (e.g., 20) comprises a first latch (e.g., 201) and a second latch (e.g., 202) which are configured to overhang from the first sidewall (e.g., 23) of the inner shell (e.g., 20), the first engaging portion of the first connecting portion (e.g., 110) comprises a first recess (e.g., 111) cooperating with the first latch (e.g., 201) and a second recess (e.g., 113) cooperating with the second latch (e.g., 202), and the first recess (e.g., 111) and the second recess (e.g., 113) are open towards the inner shell (e.g., 20) in the thickness direction (e.g., Z), wherein a first distal end of the first latch (e.g., 201) and a second distal end of the second latch (e.g., 202) extend towards an inner side of the inner shell (e.g., 20) and are received in the first recess (e.g., 111) and the second recess (e.g., 113), respectively, when the inner shell (e.g., 20) is assembled with the first connecting portion (e.g., 110).

4. The receptacle connector according to aspect 3 or any other aspect, wherein the second engaging portion of the inner shell (e.g., 20) comprises a third latch (e.g., 203) and a fourth latch (e.g., 204) which are configured to overhang from the second sidewall (e.g., 25) of the inner shell (e.g., 20), the first engaging portion of the first connecting portion (e.g., 110) comprises a third recess (e.g., 115) cooperating with the third latch (e.g., 203) and a fourth recess (e.g., 117) cooperating with the fourth latch (e.g., 204), and the third recess (e.g., 115) and the fourth recess (e.g., 117) are open towards the inner shell (e.g., 20) in the thickness direction (e.g., Z), wherein a third distal end of the third latch (e.g., 203) and a fourth distal end of the fourth latch (e.g., 204) extend towards an inner side of the inner shell (e.g., 20) and are received in the third recess (e.g., 115) and the fourth recess (e.g., 117), respectively, when the inner shell (e.g., 20) is assembled with the first connecting portion (e.g., 110).

5. The receptacle connector according to any one of aspects 2 to 4 or any other aspect, wherein the housing (e.g., 11) comprises a second connecting portion (e.g., 120) connected with the first connecting portion (e.g., 110), the second connecting portion is arranged to be closer to a mating end of the housing (e.g., 11) than the first connecting portion (e.g., 110) in the mating direction (e.g., Y), and in a projection plane of the housing (e.g., 11) perpendicular to the mating direction (e.g., Y), an outer contour shape of the first connecting portion (e.g., 110) is larger than an outer contour shape of the second connecting portion (e.g., 120), and the second connecting portion (e.g., 120) comprises a protrusion (e.g., 151, 153) extending outwardly from an outer surface of the housing (e.g., 11), and the inner shell (e.g., 20) comprises a bore (e.g., 252, 254) for engaging with the protrusion.

6. The receptacle connector according to aspect 5 or any other aspect, wherein the cylindrical portion (e.g., 22) comprises a flange (e.g., 208) having an annular shape, the flange of the cylindrical portion (e.g., 22) extends in a plane perpendicular to the mating direction, the inner shell (e.g., 20) comprises a first extension (e.g., 24) and a second extension (e.g., 26), the first extension (e.g., 24) and the second extension (e.g., 26) both are connected with the flange of the cylindrical portion (e.g., 22) and extend from the flange of the cylindrical portion (e.g., 22) in a plane perpendicular to the thickness direction (e.g., Z), and the first extension (e.g., 24) and the second extension (e.g., 26) are provided on opposite sides of the second connecting portion (e.g., 120) of the housing (e.g., 11) in the thickness direction (e.g., Z).

7. The receptacle connector according to aspect 6 or any other aspect, wherein the first extension (e.g., 24), the second extension (e.g., 26) and the cylindrical portion (e.g., 22) are formed as an integral shielding metal member, and each of the first extension (e.g., 24) and the second extension (e.g., 26) fits with at least a portion of an outer circumferential surface of the second connecting portion (e.g., 120) of the housing (e.g., 11).

8. The receptacle connector according to aspect 6 or any other aspect, wherein the protrusion (e.g., 151, 153) has an L-shaped shape in a cross-section perpendicular to a width direction of the receptacle connector, the width direction (e.g., X) is perpendicular to both the mating direction (e.g., Y) and the thickness direction (e.g., Z), and the protrusion is arranged at a connecting portion where the first connecting portion (e.g., 110) is connected with the second connecting portion (e.g., 120), wherein at least one portion of the bore of the inner shell (e.g., 20) is provided on the first extension (e.g., 24) and/or the second extension (e.g., 26), and the other portion of the bore of the inner shell (e.g., 20) is provided on the flange (e.g., 208) of the cylindrical portion (e.g., 22).

9. The receptacle connector according to aspect 5 or any other aspect, wherein the housing (e.g., 11) comprises a third connecting portion (e.g., 160), wherein the third connecting portion (e.g., 160) is provided on the side of the first connecting portion (e.g., 110) that is opposite to the second connecting portion (e.g., 120) and is located adjacent to a rear end of the housing (e.g., 11), and in a projection plane of the housing (e.g., 11) perpendicular to the mating direction (e.g., Y), an outer contour shape of the third connecting portion (e.g., 160) is larger than an outer contour shape of the first connecting portion (e.g., 110) such that at least a portion of a rear end surface of the main shell (e.g., 30) and a rear end surface of the outer shell (e.g., 40) abuts against a mating end of the third connecting portion (e.g., 160).

10. The receptacle connector according to any one of aspects 1 to 4 or any other aspect, wherein the plurality of electrically conductive elements comprises a first plurality of electrically conductive elements (e.g., 100A) and a second plurality of electrically conductive elements (e.g., 100B), the first plurality of electrically conductive elements (e.g., 100A) and the second plurality of electrically conductive elements (e.g., 100B) are arranged in rows in a width direction (e.g., X) of the receptacle connector, respectively, and the first plurality of electrically conductive elements (e.g., 100A) and the second plurality of electrically conductive elements (e.g., 100B) are spaced apart from each other in a thickness direction (e.g., Z) of the receptacle connector (e.g., 1) perpendicular to the width direction (e.g., X), and the terminal assembly (e.g., 10) further comprises a shielding member (e.g., 130) provided between the first plurality of electrically conductive elements (e.g., 100A) and the second plurality of electrically conductive elements (e.g., 100B) in the thickness direction (e.g., Z).

11. The receptacle connector according to aspect 10 or any other aspect, wherein the first plurality of electrically conductive elements (e.g., 100A) and the second plurality of electrically conductive elements (e.g., 100B) are arranged to be symmetrical with respect to a mid-plane of the shielding member (e.g., 130) perpendicular to the thickness direction.

12. The receptacle connector according to aspect 11 or any other aspect, wherein the terminal assembly (e.g., 10) comprises a first subassembly (e.g., M1) and a second subassembly (e.g., M2), the first subassembly (e.g., M1) comprises the first plurality of electrically conductive elements (e.g., 100A) and a first subassembly housing for accommodating the first plurality of electrically conductive elements (e.g., 100A), and the second subassembly (e.g., M2) comprises the second plurality of electrically conductive elements (e.g., 100B) and a second subassembly housing for accommodating the second plurality of electrically conductive elements, and the shielding member (e.g., 130) comprises a first plurality of holes and a second plurality of holes, the first subassembly housing comprises a first plurality of protrusions configured to pass through the first plurality of holes of the shielding member (e.g., 130) and extend towards the second subassembly housing, and the second subassembly housing comprises a second plurality of protrusions configured to pass through the second plurality of holes of the shielding member (e.g., 130) and extend towards the first subassembly housing.

13. The receptacle connector according to aspect 12 or any other aspect, wherein the first plurality of holes of the shielding member (e.g., 130) comprises a first hole (e.g., 131) and a second hole (e.g., 132), the first plurality of protrusions of the first subassembly housing comprises a first protrusion (e.g., 121) configured to extend through the first hole (e.g., 131) of the shielding member (e.g., 130) and a second protrusion (e.g., 122) configured to extend through the second hole (e.g., 132) of the shielding member (e.g., 130), and the second subassembly housing comprises a first recess (e.g., 141) corresponding to the first protrusion (e.g., 121) and a second recess (e.g., 142) corresponding to the second protrusion (e.g., 122), when the first subassembly (e.g., M1), the shielding member (e.g., 130) and the second subassembly (e.g., M2) are assembled, the first protrusion (e.g., 121) of the first subassembly (e.g., M1) extends through the first hole (e.g., 131) of the shielding member (e.g., 130) and is disposed in the first recess (e.g., 141) of the second subassembly (e.g., M2), and the second protrusion (e.g., 122) of the first subassembly (e.g., M1) extends through the second hole (e.g., 132) of the shielding member (e.g., 130) and is disposed in the second recess (e.g., 142) of the second subassembly (e.g., M2).

14. The receptacle connector according to aspect 13 or any other aspect, wherein the second plurality of holes of the shielding member (e.g., 130) comprises a third hole (e.g., 133) and a fourth hole (e.g., 134), the second plurality of protrusions of the second subassembly housing comprises a third protrusion (e.g., 143) configured to extend through the third hole (e.g., 133) of the shielding member (e.g., 130) and a fourth protrusion (e.g., 144) configured to extend through the fourth hole (e.g., 134) of the shielding member (e.g., 130), and the first subassembly (e.g., M1) comprises a third recess (e.g., 123) corresponding to the third protrusion (e.g., 143) and a fourth recess (e.g., 124) corresponding to the fourth protrusion (e.g., 144), when the first subassembly (e.g., M1), the shielding member (e.g., 130) and the second subassembly (e.g., M2) are assembled, the third protrusion (e.g., 143) of the second subassembly (e.g., M2) extends through the third hole (e.g., 133) of the shielding member (e.g., 130) and is disposed in the third recess (e.g., 123) of the first subassembly (e.g., M1), and the fourth protrusion (e.g., 144) of the second subassembly (e.g., M2) extends through the fourth hole (e.g., 134) of the shielding member (e.g., 130) and is disposed in the fourth recess (e.g., 124) of the first subassembly (e.g., M1).

15. The receptacle connector according to aspect 14 or any other aspect, wherein each of the first protrusion (e.g., 121), the second protrusion (e.g., 122), the third protrusion (e.g., 143), and the fourth protrusion (e.g., 144) is engaged with a corresponding hole in an interference-fit manner.

16. The receptacle connector according to aspect 14 or any other aspect, wherein each of the first protrusion (e.g., 121), the second protrusion (e.g., 122), the third protrusion (e.g., 143), and the fourth protrusion (e.g., 144) comprises a body extending in the thickness direction and a plurality of projections protruding radially outward from the body, and each of the first hole (e.g., 131), the second hole (e.g., 132), the third hole (e.g., 133) and the fourth hole (e.g., 134) of the shielding member (e.g., 130) is formed as a cylindrical hole, with a circumferential outer surface of the projections fitting closely with an inner surface of the corresponding hole.

17. The receptacle connector according to aspect 14 or any other aspect, wherein the first protrusion (e.g., 121), the second protrusion (e.g., 122), the third recess (e.g., 123) and the fourth recess (e.g., 124) of the first subassembly housing are arranged in a quadrilateral array, wherein the first protrusion (e.g., 121) and the second protrusion (e.g., 122) are arranged in a first diagonal of the quadrilateral array, and the third recess (e.g., 123) and the fourth recess (e.g., 124) are arranged on a second diagonal of the quadrilateral array intersecting with the first diagonal.

18. The receptacle connector according to any one of aspects 1 to 4 or any other aspect, wherein a flange portion (e.g., 41) is provided at a mating end of the outer shell (e.g., 40), the flange portion comprises an annular flange portion proximal surface extending in a plane perpendicular to the mating direction (e.g., Y), a first rough portion (e.g., 401) is provided on the flange portion proximal surface of the outer shell (e.g., 40), and the sealing member (e.g., 50) is provided to rest against the flange portion proximal surface of the outer shell (e.g., 40) and is attached to the first rough portion (e.g., 401).

19. The receptacle connector according to aspect 18 or any other aspect, wherein a second rough portion (e.g., 301) is provided on a portion of an outer sidewall of the main shell (e.g., 30) extending beyond a mating end of the outer shell (e.g., 40), and the sealing member (e.g., 50) is attached to the second rough portion (e.g., 301).

20. The receptacle connector according to aspect 19 or any other aspect, wherein each of the first rough portion (e.g., 401) and the second rough portion (e.g., 301) comprises a pattern formed by at least one of a diagonal pattern, a grid pattern, or a predetermined symbol pattern.

21. The receptacle connector according to aspect 20 or any other aspect, wherein the predetermined symbol pattern comprises at least one of a starlike shape, an H shape, or an X shape.

22. The receptacle connector according to aspect 19 or any other aspect, wherein a size of the sealing member (e.g., 50) in the mating direction is set in a range of 0.1 mm to 5 mm.

23. The receptacle connector according to any one of aspects 1 to 4 or any other aspect, wherein the receptacle connector is mounted in an electrical device, and the sealing member (e.g., 50) is an elastically deformable member and is configured to elastically deform when the sealing member (e.g., 50) is in contact with the mounting portion of the electronic device, so as to form an interference fit with the mounting portion of the electronic device in a direction perpendicular to the mating direction.

24. The receptacle connector according to aspect 19 or any other aspect, wherein the scaling member (e.g., 50) is configured to have an annular shape extending circumferentially and continuously around a mating end of the main shell (e.g., 30), and the sealing member (e.g., 50) is configured to have an attachment surface forming a positive-fit with an outer sidewall of the main shell (e.g., 30) and the flange portion proximal surface of the outer shell (e.g., 40).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector comprising:
a housing comprising a first portion having a first contour, a second portion extending from the first portion and having a second contour smaller than the first contour of the first portion, and a tongue extending from the second portion;
a plurality of conductive elements, each of the plurality of conductive elements comprising a mating end held by the tongue portion of the housing, a tail end extending out of the housing, and an intermediate portion between the mating end and the tail end and at least partially held by the first and second portions of the housing; and
an inner shell comprising a first portion engaging the first portion of the housing, and a second portion engaging the second portion of the housing.

2. The receptacle connector of claim 1, wherein:
the first portion of the housing comprises a recess; and
the first portion of the inner shell comprises a latch disposed in the recess of the first portion of the housing.

3. The receptacle connector of claim 1, wherein:
the inner shell comprises an opening; and
the housing comprises a protrusion disposed in the opening of the inner shell.

4. The receptacle connector of claim 3, wherein:
the protrusion of the housing extends from the first portion of the housing to the second portion of the housing.

5. The receptacle connector of claim 4, wherein:
a cross-section of the protrusion of the housing is L-shaped.

6. The receptacle connector of claim 3, wherein:
the inner shell comprises a flange joining the first portion of the inner shell and the second portion of the inner shell; and
the opening of the inner shell extends from the flange to the second portion of the inner shell.

7. The receptacle connector of claim 1, wherein:
the housing comprises a third portion having a third contour larger than the first contour; and
the first portion of the housing is disposed between the third portion of the housing and the second portion of the housing.

8. The receptacle connector of claim 7, comprising:
a main shell disposed outside the inner shell and comprising a rear end abutting a front face of the third portion of the housing and a mating end extending beyond the tongue of the housing.

9. The receptacle connector of claim 8, comprising:
an outer shell disposed outside the main shell, the outer shell comprising a mating end having a flange and a rear end having a plurality of mounting legs; and
a seal disposed between the flange of the outer shell and the mating end of the main shell.

10. The receptacle connector of claim 9, wherein:
the mating end of the main shell has a surface roughness higher than other portions of the main shell; and
the seal comprises cured adhesive.

11. A receptacle connector comprising:
a shielding member comprising a plurality of holes;
a plurality of conductive elements each comprising a mating end, a tail end, and an intermediate portion between the mating end and the tail end, the plurality of conductive elements comprising a first plurality disposed on a first side of the shielding member and a second plurality disposed on a second side of the shielding member opposite the first side; and
a housing comprising a plurality of protrusions disposed in respective holes of the plurality of holes of the shielding member, each of the plurality of protrusions comprising a body and a plurality of projections extending radially from the body to engage edges of the respective holes.

12. The receptacle connector of claim 11, wherein:
the housing comprises a first portion and a second portion extending from the first portion; and
the receptacle connector comprises an inner shell comprising a first portion disposed on the first portion of the housing, a flange extending from the first portion, and a second portion extending from the flange and disposed on the second portion of the housing.

13. The receptacle connector of claim 12, wherein:
the second portion of the housing comprises the plurality of protrusions disposed in the respective holes of the plurality of holes of the shielding member.

14. The receptacle connector of claim 11, wherein:
the housing comprises a third portion disposed on a different side of the first portion of the housing from the second portion of the housing and spaced from the first portion of the housing; and
the receptacle connector comprises a main shell having a rear end abutting a front face of the third portion of the housing.

15. The receptacle connector of claim 14, comprising:
an outer shell disposed outside the main shell and having a rear end abutting the front face of the third portion of the housing,
wherein the rear end of the outer shell comprises a plurality of mounting legs extending beyond the third portion of the housing.

16. The receptacle connector of claim 15, wherein:
the main shell comprises a mating end having a surface roughness higher than other portions of the main shell;
the receptacle connector comprises a seal disposed on the mating end of the main shell; and
the seal comprises cured adhesive.

17. The receptacle connector of claim 16, wherein:
the receptacle connector complies with USB Type-C standard.

18. A method of manufacturing a receptacle connector, comprising:
providing first and second terminal subassemblies, each of the first and second terminal subassembly comprising a plurality of conductive elements held by a subassembly housing;
assembling one of the first and second terminal subassemblies on a first side of a shielding member comprising inserting protrusions of the subassembly housing of the respective terminal subassembly into first holes of the shielding member;
assembling the other one of the first and second terminal subassemblies on a second side of the shielding member comprising inserting protrusions of the subassembly housing of the respective terminal subassembly into second holes of the shielding member; and
molding over the assembled first and second terminal subassemblies and the shielding member to form a terminal assembly.

19. The method of claim 18, comprising:
assembling an inner shell on the housing of the terminal assembly comprising:
fitting protrusions of the housing into openings of the inner shell; and
engaging latches of the inner shell with the housing.

20. The method of claim 19, comprising:
assembling a main shell outside the inner shell and the terminal assembly;
assembling an outer shell outside the main shell; and
forming a seal between mating ends of the main shell and the outer shell by applying an adhesive and curing the adhesive.
